(19) United States
(12) Patent Application Publication
(10) Pub. No.: US 2010/0126789 A1
(43) Pub. Date: May 27, 2010

(54) Personal Vehicles

(75) Inventor: Fred Scragg, Jersey (GB)

Correspondence Address: BARNES & THORNBURG LLP, P.O. BOX 2786, CHICAGO, IL, 60690-2786, US

(73) Assignee: Green Island Holding Co. Ltd.

(21) Appl. No.: 12/517,464

(22) PCT Filed: Dec. 4, 2007
(86) PCT No.: PCT/GB2007/050738

§ 371 Date: Jun. 23, 2009

(30) Foreign Application Priority Data
Dec. 4, 2006 (GB) 0624200.2

(51) Int. Cl. B62D 61/00; B62M 1/00; B62B 3/02

(52) U.S. Cl. 180/208; 280/649; 280/647; 280/87.05

(57) ABSTRACT

An electric scooter (1) comprises a collapsible chassis (2), a pair of driven wheels (4) at the front of the chassis (2) and a pair of casters (5) at the rear. An upright column (6) is supported on the chassis (2) and a foldable seat (3) is supported on the column (6). The chassis (2) comprises a pair of cross-members that make up an X-frame, such that the chassis (2) may readily be folded. The back of the seat (3) may fold down onto the base of the seat and they may together be pivoted downwardly and rotated through 90°, so that they fall within the plan area of the folded chassis. The height of the seat (3) on the column (6) is adjustable, to facilitate transfer of a user to and from the seat (3). An electric wheelchair is also disclosed.

This invention relates to personal vehicles and is concerned particularly although not exclusively with self-propelled personal vehicles.

In the context of this specification, the term “self-propelled personal vehicle” means a vehicle that is adapted for use by one seated person and is provided with powered drive means that propels the vehicle under the control of the user. Examples of such vehicles include electrically powered wheelchairs and electrically powered scooters, sometimes referred to as electric convenience vehicles (ECVs). Although electric motors powered by rechargeable batteries afford the almost universal power source at the present time for wheelchairs and scooters, it is of course conceivable to have alternative power sources.

Wheelchairs have been used for very many years and are indispensable to allow people with disabilities, permanent or temporary, to get around. These days, much travelling is done by car or other transport. To enable users to travel with their wheelchairs, as well as reduce the space occupied when not in use, many are foldable or collapsible.

To this end, most folding wheelchairs have a seat and a backrest, each of which comprises a strap of flexible material that is supported on a frame of the wheelchair at each end of the strap. The strap of material simply folds up as the wheelchair itself is collapsed or folded.

Whilst such straps of material may be tolerated for short periods of use, they can be extremely uncomfortable for those who have to use wheelchairs for long periods. Not only is there discomfort, but the poor posture resulting from their use can lead to permanent damage to the user's body.

In addition to the above, a user of a typical, present day wheelchair often has difficulty in transferring between the wheelchair and another chair, toilet, or surface. Footrests on wheelchairs often cause obstructions when not in use, and can readily damage a user, who is likely to be able to move only with difficulty.

Although various proposals have been made for different designs of wheelchairs over the years, it is a regrettable fact that, even in this twenty-first century, there exists no wheelchair that provides a comfortable and medically acceptable long-term sitting position for a user, whilst remaining light, collapsible and easy to transport, and also affording ease of transfer into and out of the wheelchair.

A further problem that arises particularly with wheelchairs is the inability to negotiate narrow passageways. This can be seen every day, for example, on modern airlines where, despite the high degree of sophistication of the aircraft, manoeuvring a wheelchair-bound passenger to and from an aircraft seat is a very laborious and uncomfortable exercise, for passenger and helpers alike.

Preferred embodiments of the present invention aim to provide wheelchairs that are generally improved in the foregoing respects.

WO 88/03399 discloses a manual wheelchair intended to provide a lighter-weight construction by utilising plastics materials in a unitary structure. The height of a footrest above ground level can be adjusted, whilst maintaining a fixed distance between footrest and seat. The footrest height can be adjusted to be close to the ground. A brief mention is made of a folding seat option, but there is little information about how this may be constructed or mounted.

Wheelchair users can experience a frightening sensation of their electric wheelchair “having a mind of its own” and heading for the edge of a pavement (sidewalk), when the pavement has a lateral slope down towards the road. The user knows that, if any of their wheels goes over the edge, the wheelchair is highly likely to topple into the road and deposit them under the wheels of a lorry/car/bus. This wandering behaviour of the wheelchair may be associated with having front casters, ahead of driven wheels. If there is a lateral slope, then the front casters will tend to follow the downward slope under the influence of gravity, and using the wheelchair controls to try and turn away from the pavement edge may have little effect. However, in preferred embodiments of the invention utilising Front Wheel Drive, the problem may be much alleviated or disappear, as trailing castors may not exhibit such a tendency to have “a mind of their own”.

Wheelchairs generally afford access to a user from the front of the chair and, typically, electric wheelchairs have user controls located on an armrest of the chair. Another type of self-propelled personal vehicle that has become popular in more recent times is the electrically powered scooter, sometimes referred to as an electric convenience vehicle (ECV). Generally speaking, electric scooters are used by people who have difficulty walking for more than short distances. They typically have a steering column at the front of the vehicle. The user enters the scooter at the side of the vehicle. In an interesting contrast to the position with wheelchairs, electric scooters are often provided with more comfortable seats. One possibility for this is that electric scooters are not widely regarded as vehicles to be collapsed and transported in, say, a car, with the user. Therefore, they tend to be built more heavily than collapsible wheelchairs. Although some electric scooters are designed to be disassembled and transported in the boot of a car, such designs tend to be heavy, bulky and have a large turning circle.

According to one aspect of the present invention, there is provided a personal vehicle comprising:

a) a collapsible chassis;

b) a plurality of wheels mounted at extremities of the chassis;

c) an upright column supported on the chassis; and

d) a foldable seat supported on the column.

Preferably, said collapsible chassis comprises a plurality of structural members that are interconnected such that, in plan view, they are movable between an operational position in which the chassis has a maximum width and a stowage position in which the chassis has a reduced width.

Preferably, the personal vehicle further comprises locking means arranged to lock said structural members in at least one intermediate position in which the chassis has a width intermediate said maximum and reduced widths.

Preferably, said structural members are connected to a common pivot point, for pivoting movement about an upright axis.

Preferably, said structural members comprise two members that are pivotally connected in a substantially X-configuration.

Preferably, said chassis further comprises at least one guide member to which the structural members are connected such that, as the structural members are moved between said operational and stowage positions, extremities of the chassis maintain a substantially parallel relationship to one another.

Preferably, wherein four said wheels are provided at respective extremities of the chassis.

Alternatively, only three said wheels are provided at respective extremities of the chassis.

Preferably, the personal vehicle further comprises at least one prime mover arranged to drive at least one of said wheels.

Preferably, two driven wheels are provided at the front of the chassis.

Preferably, the personal vehicle further comprises control means arranged to control the drive to said two driven wheels independently, thereby to provide a steering function.

Preferably, said prime mover comprises an electric motor.

Preferably, two said prime movers are provided, each arranged to drive a respective one of said wheels.

Preferably, the personal vehicle further comprises height adjustment means arranged to adjust the height of said seat on said column.

Preferably, said height adjustment means is arranged to adjust the height of said seat with respect to a surface on which the user's feet rest in use.

Preferably, said height adjustment means includes a powered drive arranged to adjust the height of said seat.

Preferably, the personal vehicle further comprises control means arranged to control said powered drive such that said seat may be adjusted to at least one pre-set height.

Preferably, said seat comprises a seat squab and a seat back that are arranged to fold together.

Preferably, said seat squab and seat back are arranged to pivot about a substantially horizontal axis when folded together, thereby to bring the seat squab and seat back into or towards alignment with said column.

Preferably, said seat is arranged to pivot about an upright axis.

Preferably, said seat is provided with armrests that can be moved into and out of operational positions.

Preferably, the personal vehicle comprises a chassis assembly and a seat assembly that is removable from said chassis assembly.

Preferably, the personal vehicle is provided with at least one removable battery pack that is arranged to power at least one electrical device of the vehicle.

A personal vehicle as above may comprise a wheelchair or a scooter.

For a better understanding of the invention and to show how embodiments of the same may be carried into effect, reference will now be made, by way of example, to the accompanying diagrammatic drawings, in which:

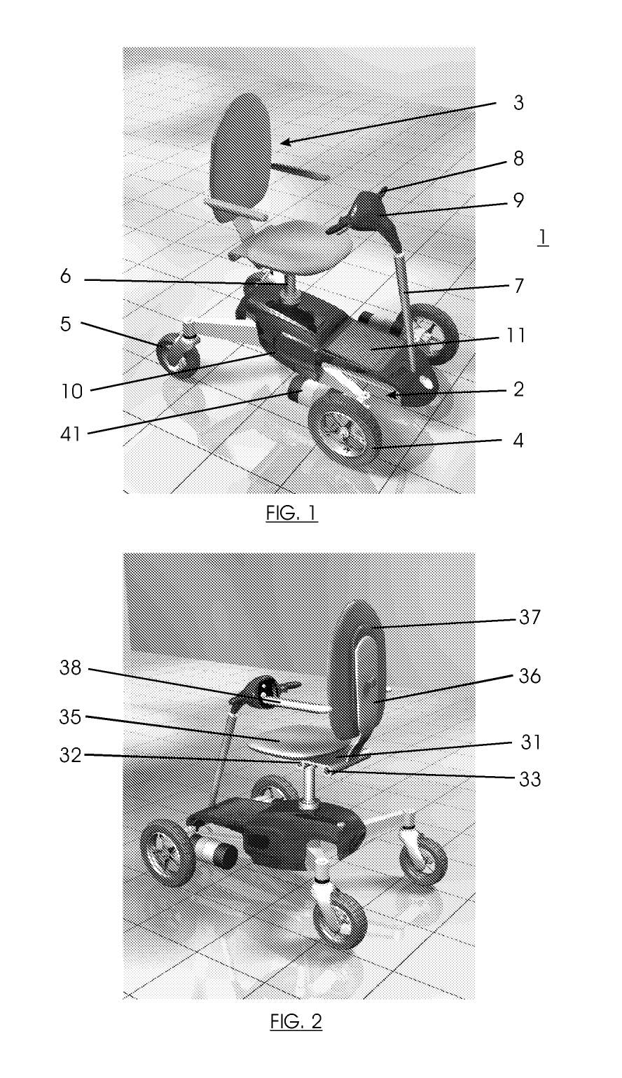

FIG. 1 is a perspective view from the front and one side of one example of an electric scooter embodying the present invention;

FIG. 2 is another perspective view of the scooter from the rear and opposite side;

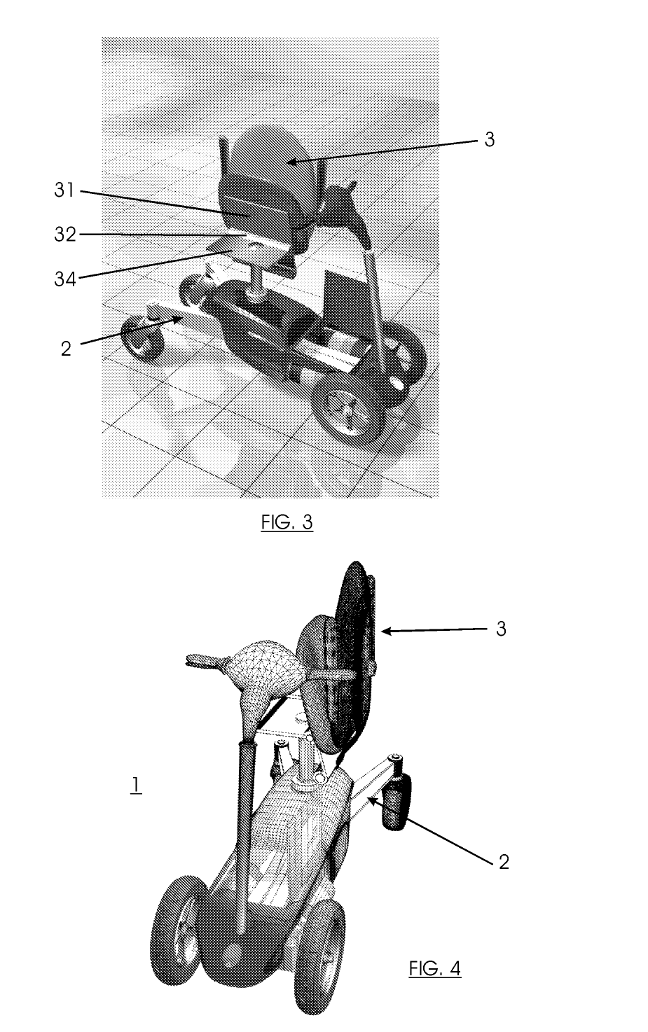

FIG. 3 is a perspective view similar to that of FIG. 1, but showing the scooter in a folded position;

FIG. 4 is a perspective view from the front and opposite side, showing the scooter in a folded position;

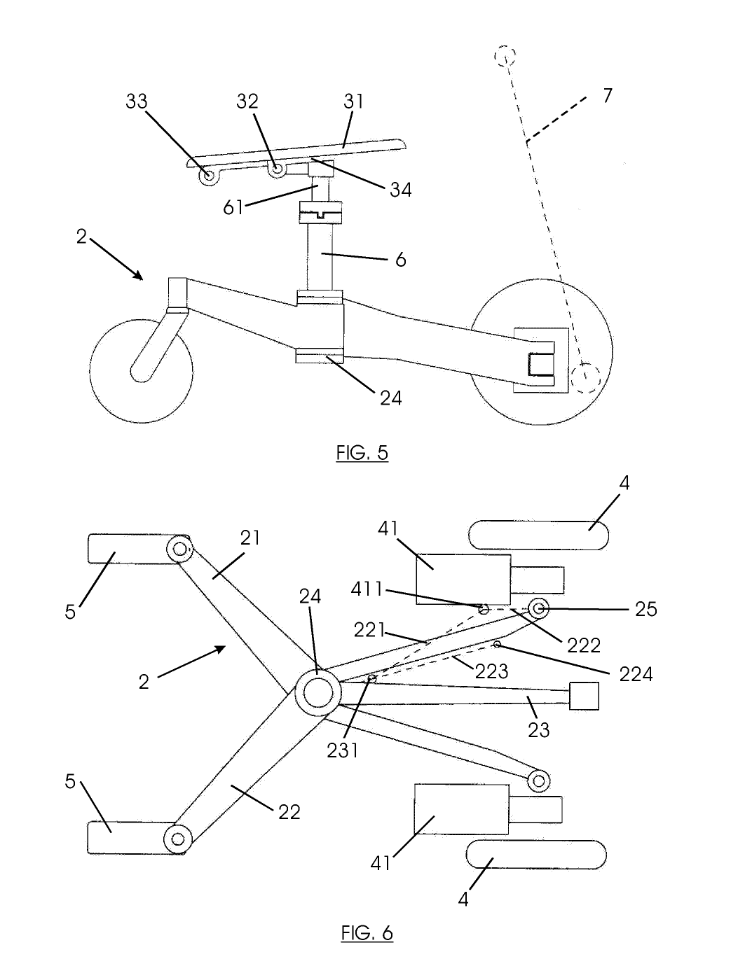

FIG. 5 is a diagrammatic side view of the scooter, with seat parts removed;

FIG. 6 is a diagrammatic plan view of the scooter, with seat parts removed;

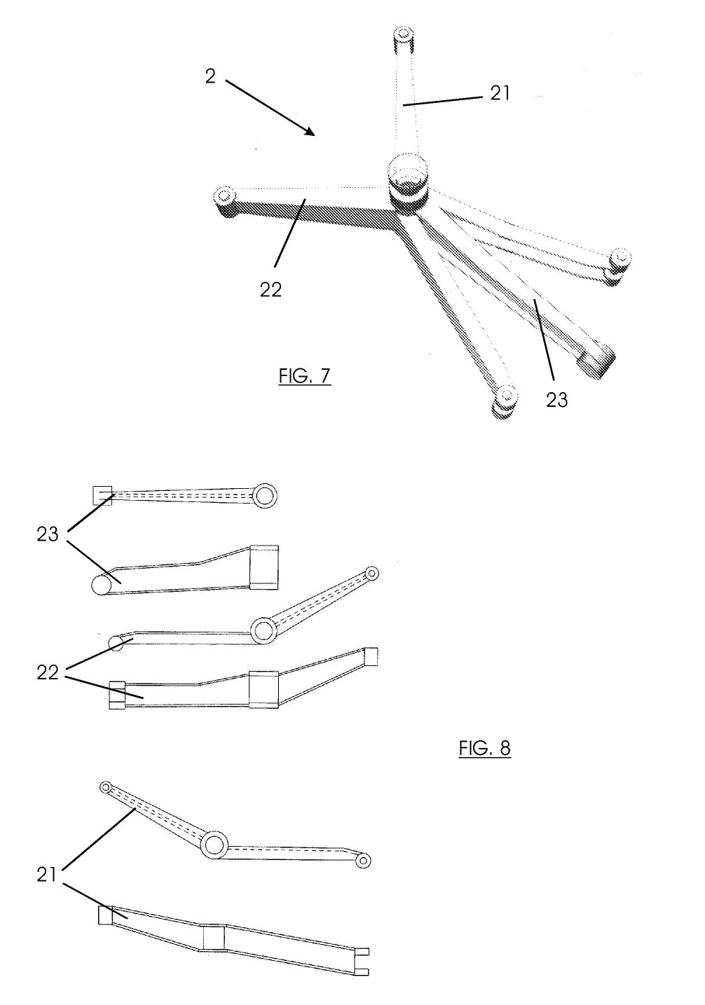

FIG. 7 is a perspective view of a base sub-assembly of the scooter;

FIG. 8 is a diagrammatic view of various parts of the base sub-assembly shown in FIG. 7;

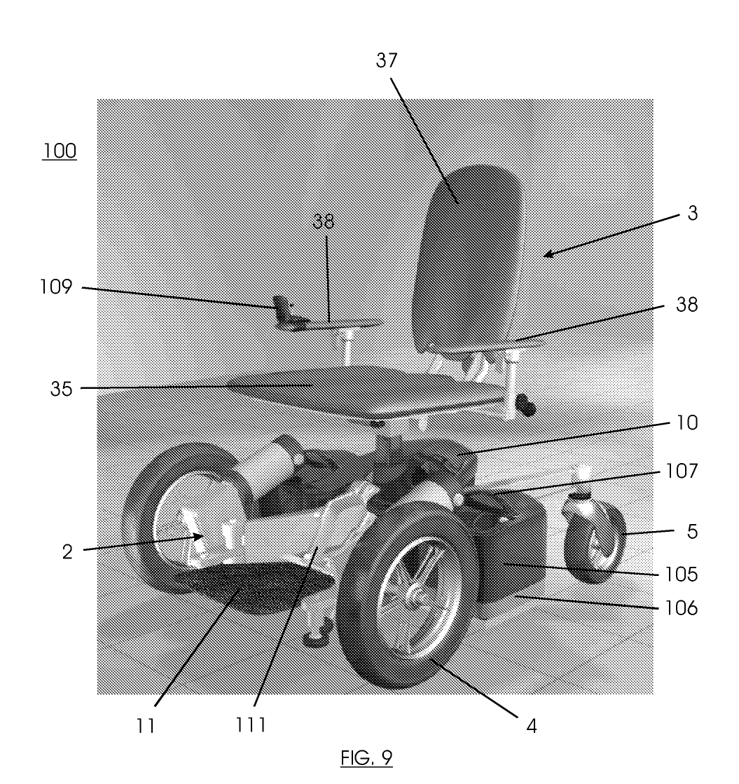

FIG. 9 is a perspective view from the front and one side of one example of an electric wheelchair embodying the present invention;

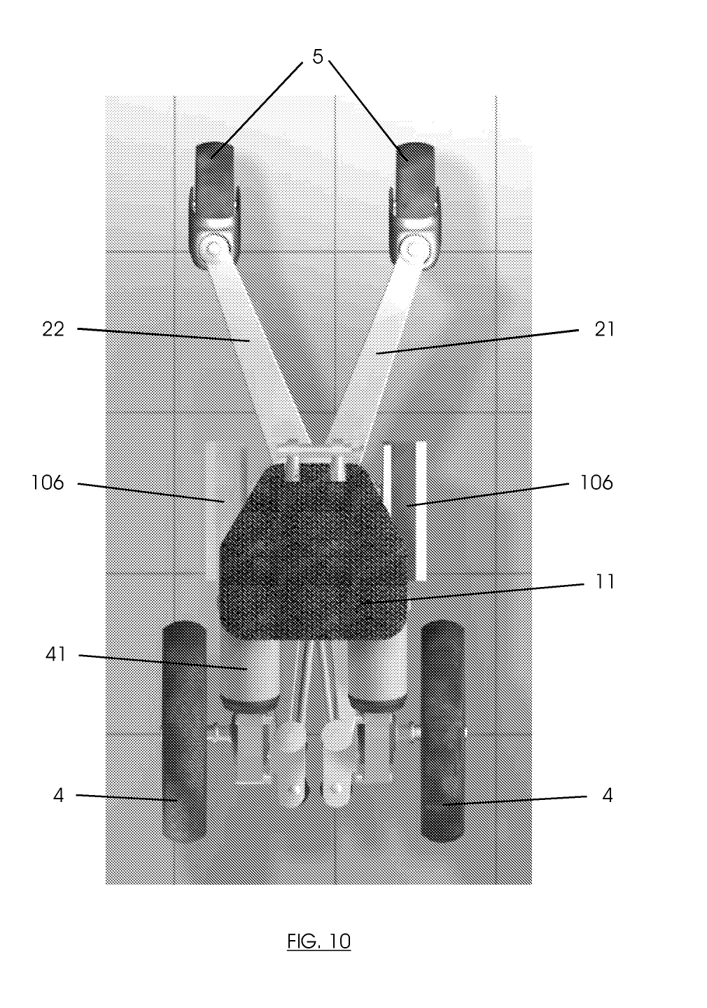

FIG. 10 is a top plan view of the wheelchair in a folded position, with a seat sub-assembly removed;

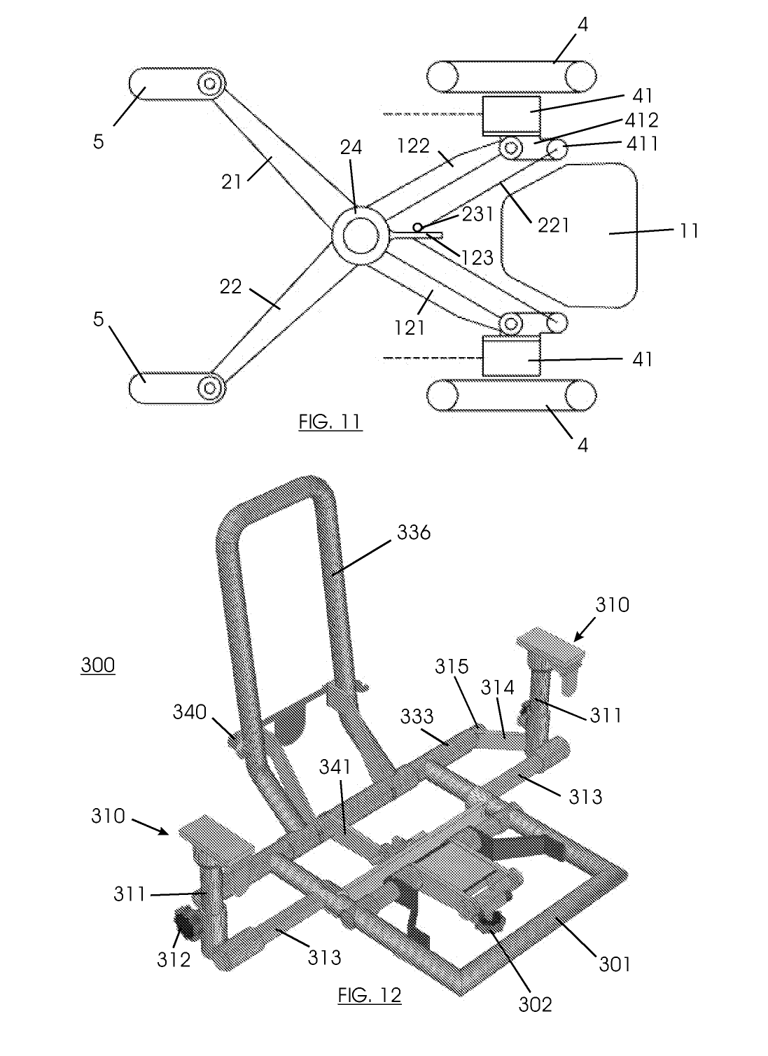

FIG. 11 is a diagrammatic plan view of the wheelchair, with seat parts removed;

FIG. 12 is a perspective view of a seat sub-assembly of the wheelchair, with seat parts removed; and

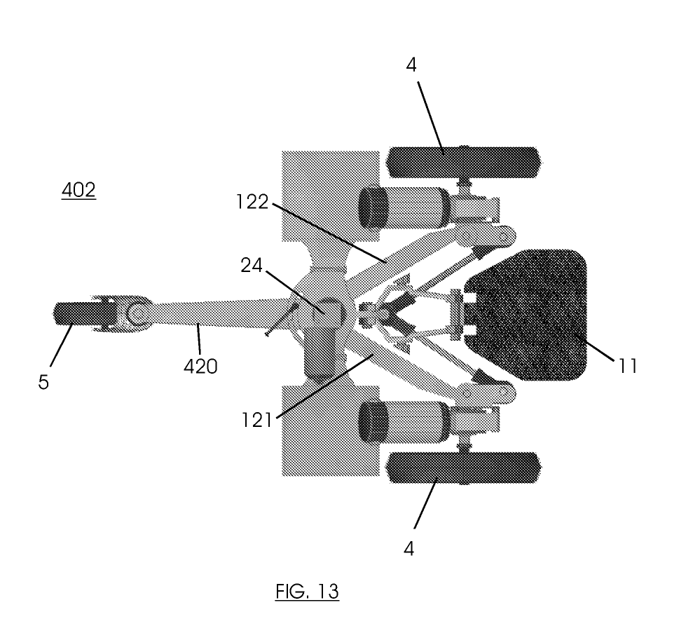

FIG. 13 is a plan view similar to that of FIG. 11, but showing a modified shape of frame.

In the figures, like reference numerals denote like or corresponding parts.

The illustrated electric scooter 1 comprises a base sub-assembly 2 and a seat sub-assembly 3. The base sub-assembly 2 carries a pair of driven wheels 4 at the front of the scooter 1 and a pair of casters 5 at the rear. A seat column 6 is supported on the base sub-assembly 2 and carries the seat sub-assembly 3. Also mounted on the base sub-assembly 2 is a control column 7 at the top of which is a pair of handlebars 8, at either side of a control panel 9. Mounted over the base sub-assembly 2 is a body or housing 10, on which a footrest 11 is pivotally mounted.

Each of the wheels 4 is driven by a respective electric motor 41, controlled via the control panel 9. The motors 41 are powered by an electric battery (not shown), housed within the body 10.

In use, a user 6 sits on the seat 3 and drives the scooter 1 by operation of the handlebars 8 and control panel 9. Preferably, steering is effected by driving the wheels 4 differentially, in dependence upon the angular position of the handlebars 8 with respect to the control column 7. That is, as the handlebars 8 are rotated, the electric motors 41 are driven at different speeds, thereby to cause the scooter 1 to turn. For very tight turns, one of the motors 41 may be driven in reverse whilst the other motor is driven forward. It will be appreciated that, in this manner, the scooter may have a much tighter turning circle than previously proposed scooters and therefore be much more suitable for use in confined spaces—for example, inside houses. A similar consideration applies to wheelchairs that are described below. Speed may be controlled by rotation of one of the handlebars 8, in a twist-grip manner. The art of controlling electric motors to effect both speed and steering control is well known and therefore is not described further in detail here.

The control panel 9 may provide various user functions and displays. For example, it may indicate speed, battery condition, etc. It may provide a security lock, choice of speed ratios, reverse selection, warning device (e.g. horn), indicator controls, etc.

As may be seen in FIGS. 1 and 2, the illustrated scooter 1 is of a compact design that lends itself well to lightweight construction. However, more than that, the scooter 1 is designed to be collapsed for easy loading into, for example, the boot of a car, such that it may be transported along with its user.

FIGS. 3 and 4 shows the scooter 1 in its folded condition, in which the base sub-assembly 2 has been collapsed to narrow dimensions and the seat sub-assembly 3 has been collapsed such that its overall dimensions fit within the overall plan dimensions of the collapsed scooter 1. The features of the scooter 1 that allow it to be collapsed in this way will now be described in further detail.

The base sub-assembly 2 comprises a pair of cross-members 21, 22 which, pivotally mounted together with a guide member 23, make up an X-frame. The base members 21, 22 and 23 are all structural members that give strength to the base sub-assembly 2. Each of the base members 21, 22 and 23 is shown in plan and side elevation in FIG. 8.

The cross-members 21, 22 may be pivotally moved towards and away from one another and the guide member 23, in order to decrease and increase the overall width of the base sub-assembly 2. Each of the cross-members 21, 22 carries a wheel sub-assembly at the forward end 25 thereof, the wheel sub-assembly comprising a respective electric motor 41 with drive transmission and driven wheel 4. A respective one of the casters 5 is mounted at the rear end of each of the cross-members 21, 22. The control column 7 is mounted at the forward end of the guide member 23, as shown in chain lines in FIG. 5.

The seat column 6 is mounted at the pivot point 24 and may conveniently provide the pivot point 24 for the base members 21, 22 and 23.

The seat column 6 is telescopic, having an upper part 61 that may be raised and lowered under user control. Preferably, an electric motor with suitable gearing is provided to raise and lower the upper column part 61. However, any other suitable means may be provided for that purpose. As seen in FIG. 5, a seat base 31 is provided at the top of the upper column part 61 and affords first and second hinges 32 and 33.

Referring now to FIGS. 2 and 3, a mounting plate 34 is mounted at the top of the upper column part 61 and is pivotally connected to the seat base 31 by the first hinge 32. A seat back 36 is pivotally mounted on the seat base 31 by the second hinge 33. A base pad 35 is secured to the base plate 31 and a back pad 37 is secured to the seat back 36, such as to be adjustable in vertical position. As illustrated, the seat and back pads 35, 37 are of a simple construction. However, they may be as sophisticated as required, in order to provide comfort and proper support to a long-term user of the scooter 1. Armrests 38 are pivotally mounted on the seat back 36 and pass through the back pad 37. They may pivot between a generally upright storage position (as seen in FIG. 3), where they are in line with the seat back 36, and a generally horizontal, operative position, where they may support the arms of a user (as seen in FIGS. 1 and 2). Means may be provided for locking the armrests 38 in any desired operative position. The armrests 38 may pivot together or independently.

In order to collapse the scooter 1 from its operative position as shown in FIGS. 1 and 2, the armrests 38 are firstly pivoted upwardly until they are generally in line with the seat back 36. The seat back 36 is then folded downwardly about the second hinge 33, until it is lying adjacent the seat base 31. The seat base 31 is then pivoted about the first hinge 32 until both the seat base 31 and the seat back 36 are substantially upright. Thereafter, the seat sub-assembly 3 is rotated 90 degrees until it occupies the position shown in FIG. 3.

The footrest 11 is then pivoted upwardly to bring it out of engagement with the base sub-assembly 2 (further described below). This allows the X-frame to be collapsed until the scooter 1 occupies the position illustrated in FIG. 3.

2 0 As indicated above, when in the position illustrated in FIGS. 3 and 4, all of the electric scooter 1 occupies a space that, in plan view, falls within the maximum external dimensions of the base sub-assembly 2. The scooter 1 is therefore conveniently packed, ready to be loaded into, for example, the boot of a car, for transport with the user.

In order to bring the scooter 1 back into its operative condition, the X-frame is firstly expanded until it reaches its maximum width. The footrest 11 is then pivoted downwardly until it engages with the base sub-assembly 2, in order to lock the cross-members and guide member 21, 22 and 23 into locked positions. The seat sub-assembly 3 is rotated back through 90 degrees, the seat base 31 is pivoted downwardly about the first hinge 32, the seat back 36 is pivoted upwardly about the second hinge 33 and, finally, the armrests 38 are pivoted downwardly into their operative positions. The electric scooter 1 is then ready for use.

It will be appreciated from the foregoing that the scooter 1 may readily be collapsed for transport or storage and subsequently expanded again for use. The simple and lightweight construction of the scooter parts make for relatively simple operation. If desired, various parts of the scooter 1 may be removed for transport or storage. For example, the seat sub-assembly 3 may be removable from the seat column 6. The electric batteries for the motors 41 may be made readily removable and replaceable, since batteries are often heavy. The wheels 4 may be removable.

Further details will now be given of an arrangement for maintaining the wheels 4 in a substantially parallel relationship.

Referring to FIG. 6, a parallel linkage is provided for the cross-member 22. A first link member 221 extends between a pivot point 231 on the guide member 23 and a pivot point 411 on the housing of the electric motor 41, which is in a fixed relationship with its respective wheel 4. The pivot point 231 is mounted for sliding movement along the guide member 23. A second link member 222 extends between the pivot point 411 and the forward mounting point 25 for the respective wheel 4. A third link member 223 extends between the pivot point 231 and a further pivot point 224 mounted on the cross-member 22. The three link members 221, 222 and 223 make up, together with the cross-member 22, a parallel linkage that maintains the wheel 4 substantially parallel to the guide member 23. Restraining movement of any part of the parallel linkage will lock the respective wheel 4 in position with respect to the guide member 23. Thus, when the footrest 11 engages the body housing 10, it also engages pivot point 231 on the guide member 23, thereby to lock the pivot point 231 and therefore the respective wheel 4 in position. Alternative means may be provided for locking any other part of the parallel linkage. A similar parallel linkage is provided for the other cross-member 21.

It may be appreciated from the above that, although the illustrated electric scooter 1 is designed for use only in one, expanded position, it is possible to modify the design such that the cross-members and guide member 21, 22 and 23 may be locked in position at any intermediate point between the minimum and maximum widths of the base sub-assembly 2. In such a modification, the scooter may operate at reduced width, which can be advantageous where narrow passageways are encountered. Means may be provided for limiting the speed of the vehicle when operating at reduced width.

Alternative modes of steering may be employed if desired. For example, a direct steering link between handlebars 8 and wheels 4 may be provided, as may a reverse gear.

As indicated above, it is customary to enter an electric scooter from the side. In the embodiment illustrated in FIGS. 1 to 8, one or both of the armrests 38 would typically be raised, in order to facilitate entry. In an electric wheelchair, the user will normally enter from the front of the chair. Therefore, as compared to the electric scooter 1 illustrated in FIGS. 1 to 8, there will be no control column 7. Instead, controls for the wheelchair will typically be provided on one of the armrests such as 38.

An example of an electric wheelchair according to another embodiment of the present invention will now be described with reference to FIGS. 9 to 12.

The illustrated wheelchair 100 is similar in overall construction and operation to the electric scooter 1 that has been described above. In FIGS. 1 to 8 and FIGS. 9 to 12, like reference numerals denote like or corresponding parts and, where there is no substantial difference to those items already described above with reference to the electric scooter 1, a detailed description thereof will not be repeated.

The electric wheelchair 100 has a base sub-assembly 2 and a seat sub-assembly 3. Driven wheels 4 are provided at the front of the wheelchair 100 and casters 5 are provided at the rear thereof. The wheelchair 100 is shown in its operative position in FIG. 9 and it is shown in its folded condition in FIG. 10, with the seat sub-assembly 3 removed.

As indicated above, the main difference between the previously described scooter 1 and the electric wheelchair 100 is that, in the case of the wheelchair 100, the user enters from the front of the chair, where a footrest 11 is provided. The footrest 11 is mounted on a lever assembly 111, which allows the footrest 11 to be pivoted between a stowage position, as shown in FIG. 10, and an operational position, as shown in FIG. 9. The lever assembly 111 affords an end stop to the movement of the footrest 11, to define and preferably lock it in at least its operational position, and may be provided with means for adjusting the angle of inclination of the footrest 11 in its operational position.

The footrest 11 is shown as a one-piece item. However, it may alternatively be provided as a split item—for example, comprising two halves each mounted for pivotal movement about a substantially horizontal axis extending longitudinally of the wheelchair 100 at the outer edge of the footrest, such that each half can be pivoted downwardly to meet the other half in the middle of the footrest, to make up a full footrest that is similar to the footrest 11, but split along the longitudinal axis of the wheelchair 100. Each half can then be independently pivoted upwardly to vacate the space that is normally occupied by the footrest in use, thereby to facilitate access to the wheelchair seat. This may be particularly helpful for users who are able to walk a little, so that they are able to get their feet on the ground immediately in front of the wheelchair 100 when leaving or entering the wheelchair. The split-footrest assembly may be pivoted as a whole on the lever means 111 between its stowage and operational positions, as described above.

Instead of the control panel 9 of the scooter 1, the wheelchair 100 has a control unit 109 mounted on one of the armrests 38. The control panel 109 may be hard-wired to the electrical components of the wheelchair 100. However, in a particularly advantageous arrangement, a wireless link is provided between the control unit 109 and a controller mounted within the main body housing 10. For example, Bluetooth ® wireless technology may be employed. In an advantageous embodiment, the controller 109 may be removable from the armrest 38 such that it may be used as a remote control unit, which is particularly advantageous with a wireless connection to the controller. Alternatively, an additional remote control unit may be provided, to afford control in a manner similar to that afforded by the control unit 109.

It may be appreciated that the wheelchair 100 may be controlled in a manner similar to that described above with reference to the electric scooter 1. Thus, the wheels 4 may be driven by their respective electric motors 41 in response to control signals from the control unit 109, steering being provided by differential movement of the drive motors 41. The electric motors 41 may also provide braking. As may be seen in FIG. 9, the control unit 109 may advantageously employ a joystick to assist control of the wheelchair 100.

FIG. 9 shows detachable battery packs 105, each removably mounted on a respective support 106 that is carried on the base sub-assembly 2. As may be seen in FIG. 9, each of the battery packs 105 has a handle 107 by which it may be lifted off its support 106. Preferably, connection means is provided on each support 106 to afford automatic electrical connection between the battery pack 105 and the electrical components of the wheelchair 100, when the battery pack 105 is placed on its respective support 106—and automatic disconnection when the battery pack 105 is removed.

As may be seen in FIG. 10, each of the battery supports 106 may be pivoted upwardly about a substantially horizontal axis, once its respective battery pack 105 has been removed.

As may be seen in FIG. 11, the control linkage for keeping the driven wheels 4 parallel has been somewhat simplified, as compared to the arrangement shown in FIG. 6 for the electric scooter 1.

In FIG. 11, a guide member 123 extends forwards (in the direction of forward travel) for a relatively short distance, as compared with the corresponding member 23 of FIG. 6. A respective pivot point 231 is provided at each side of the guide member 123. A link member 221 extends between a respective one of the pivot points 231 and a further pivot point 411 that is provided on a link member 412, mounted with the drive motor 41/driven wheel 4 sub-assembly at the front end of the forward part 122 of cross-member 22, via a forward mounting point 25. Thus, a parallel linkage for maintaining the driven wheel 4 in the desired parallel relationship with the longitudinal axis of the wheelchair 100 is afforded by the forward part 122 of the cross-member 22, the link member 412, the link member 221 and the guide member 123. Such a parallel linkage is provided, both at the forward end 122 of the cross-member 22, as just described, and likewise at the forward end 121 of the cross-member 21.

FIG. 12 shows a seat sub-assembly 300 of the wheelchair 100, with the seat and back pads 35, 37 and the armrests 38 removed. As may be seen, the seat sub-assembly may be largely of tubular construction—for example, it may be of tubular metal and/or a suitably strong tubular plastics material. A seat back support 336 is mounted for pivotal movement about the axis of a tubular frame member 333 and may be retained in an upright position by a releasable clip 340. The angular position of a lever 341 with respect to the tubular member 333 may be adjusted—for example, by means of a thumbwheel—thereby to adjust the angle of rake of the seat back support 336.

A main tubular frame 301 provides a support for seat pad 35, which is preferably attached to the tubular frame 301 in a readily detachable manner—for example, by means of spring clips. A thumbwheel 302 may be turned to adjust the angle of tilt of the seat pad 35. The back pad 37 may likewise be attached to the seat back support 336 in a readily detachable manner.

The armrests 38 are mounted detachably on supports 310, each of which comprises a tubular upright 311 which is retained in a respective socket that can be tightened and released by a thumbwheel 312, thereby to afford ready adjustment of the height and angular position of the respective armrest 38. Adjustment of the angular position may be helpful when folding the wheelchair 100. The armrest supports 310 are mounted for rotation about respective tubular members 313 and retained in a normal upright position by links 314 that are secured to the tubular member 333 by removable plugs 315. Upon removing the plugs 315, the armrest supports 310 may readily be rotated about the respective tubular members 313, thereby to lift the armrests 38 out of the way of a user, to allow the user to move sideways off or onto the seat pad 35.

In the variation shown in FIG. 13, the two rear casters 5 are replaced by a single caster 5 mounted at the rear end of a frame member 420. To the right-hand side of the pivot point 24, as seen in FIG. 13, the base sub-assembly 402 is similar to that shown in FIG. 11. However, to the left-hand side of the pivot point 24, there is just one caster 5 on the frame member 420, instead of the two casters 5 at the trailing ends of the cross-members 21, 22.

The frame member 420 may be formed as a trailing arm of either frame member 121 or 122 (equivalent to the forward parts of the cross-members 21, 22 of FIG. 11). Alternatively, the pivot point 24 may be provided at the forward end of frame member 420 and afford a mounting point for the two forward arms 121, 122.

The base sub-assembly 402 that is shown in FIG. 13 may be employed with either a wheelchair construction—for example, similar to that illustrated in FIGS. 9 to 12—or a scooter construction—for example, similar to that illustrated in FIGS. 1 to 8. Rather than providing the trailing arm 420, the single caster 5 may be mounted below the pivot point 24.

It may be appreciated that the electric wheelchair 100 operates in a similar manner to the electric scooter 1, in terms of operation, folding for stowage and unfolding for operational use. As illustrated in FIG. 10, the seat sub-assembly 3 may be removed for transport, after folding the seat back and seat base together and pivoting them with respect to the seat column 6. Alternatively, they may remain mounted on the seat column 6, as illustrated in FIG. 3 for the scooter 1.

The illustrated electric wheelchair 300 is advantageously provided with drive motors and powered means for raising and lowering the seat. However, it may be adapted to a cheaper and lighter “manual” version. For example, the driven wheels 4 may be replaced by larger diameter wheels adapted to be propelled by hand, in the manner of a conventional wheel chair. In such a case, the manually driven wheels would typically be at the rear of the chair with casters at the front. Instead of a powered drive to raise and lower the seat, a manually operable mechanism may be provided—for example, a simple lever and racket mechanism that powers a hydraulic mechanism for raising and lowering the seat.

A particular advantage of the illustrated embodiments of the invention is that the height of the seat base with respect to the footrest is completely adjustable by the user. This facilitates transfer of the user to and from the seat, regardless of the height of the support to or from which transfer is being made. Apart from this, seat height adjustment enables the body of the user to be placed in the correct position and orientation, which is particularly important for a long-term wheelchair user.

On the matter of ease of transfer, we have noted, by way of example, that vertical seat height adjustment in a range of about 100 millimetres may solve most of the problems of most wheelchair users, in being able to transfer between the seat of the wheelchair and any other surface—for example, another seat, toilet, etc. A vertical adjustment range of 200 millimetres is likely to meet virtually all conceivable requirements.

On the matter of comfort and posture, the distance between footrest and seat needs to be adjustable for each user. If the distance is too small, the thighs will not be properly supported and the knees move apart. If the distance is too great, there is too much pressure under the thighs. Despite this, the distance between the underside of the thigh (seat) and footrest in a conventional wheelchair is typically substantially fixed and therefore it is almost always wrong. Standard design practice is to make the base of the vehicle high enough to clear obstacles. Providing user control of seat height makes the important seat-footrest dimension variable, which is of great practical use. Using readily available technology (as in modern motor cars), a user can store desired seat heights into memory such that they can be recalled instantly and set. For example, three main pre-set heights (Toilet-Seat-Bed) may be provided, rather like car memory seats. In addition, the user will benefit from a properly shaped seat where weight is borne over a large proportion of buttocks and thigh—possibly with a slight upward angle to stop slipping forward in the seat.

A further advantage of providing readily adjustable seat heights is that the user can ensure that movement is always from a higher to a lower level. For example, when transferring to a bed, the seat height may be set at around 25 mm higher than the bed. When transferring from the bed, the seat height may be set at around 25 mm lower than the bed. This can greatly facilitate movement by a user. Such height adjustments can be preset. For example, they may be part of a set of pre-set absolute heights. Alternatively or additionally, the seat height control may provide pre-set adjustments such as “25 mm up” or “50 mm down”, to cause the seat height to be either higher or lower than the surface to be transferred to or from—or simply to provide seat adjustment in increments of a useful size.

In both scooter and wheelchair embodiments of the present invention, both the seat base and the seat backrest may be properly designed and built to provide anatomically correct and comfortable support for the user, even for extended periods of time. To this end, the seat base and/or backrest may be padded, cushioned, sprung, moulded, contoured or otherwise formed to provide such suitable support. The seat base and/or backrest may be provided with removable or exchangeable parts that provide such support, for differing requirements of differing users or to provide a change for the same user. By “contoured” is meant a surface shape other than a flat surface or simple curve, the shape being adapted in some way to the shape of the body.

Although the seat base and backrest are shown in a simple fashion in the drawings for ease of representation, they can be as substantial and sophisticated as the user wishes. For example, at the present day, car manufacturers have spent vast sums in designing seats for motorists that will provide comfort and reduce fatigue over a journey of a few hours. Such design criteria can readily be applied to embodiments of the invention such that a user who, for example, may spend most of the day in a wheelchair, can remain as comfortable and avoid fatigue as much as the lucky motorist. For example, sophisticated drivers' seats in cars these days can be ventilated and even provided with vibration devices, for comfort and well being. Such features may be included in embodiments of the invention.

Thus, embodiments of the invention may provide wheelchairs and scooters having a proper seat of controllable height and adjustable space between seat and footrest or foot platform. They may be of light construction and readily collapsible for transport. Light composite plastics materials (e.g.

utilising carbon fibre) may be utilised to combine lightness with strength. Wheelchairs may have a greatly improved footrest with armrests that easily fold out of the way. Footrests on traditional wheelchairs can often damage a user, as they are often in the way and difficult for a user to avoid. Scooters may have greatly improved manoeuvrability.

In the illustrated embodiments, the base sub-assembly 2 is conveniently collapsed by folding the cross-members together. However, in a variation, a base sub-assembly may be collapsed in an alternative manner—e.g. by disengaging parts from one another.

Instead of using direct electric motors, electric pumps may be used to power hydraulic motors. In both cases, motors may be controlled to provide a braking function.

A personal vehicle such as a scooter or wheelchair will normally be a wheeled vehicle. However, it is conceivable to use alternative ground-engaging means for unusual terrain and thus the term “wheel” is to be construed correspondingly broadly in the context of this specification.

In this specification, the verb “comprise” has its normal dictionary meaning, to denote non-exclusive inclusion. That is, use of the word “comprise” (or any of its derivatives) to include one feature or more, does not exclude the possibility of also including further features.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

Examples of features that are believed to be inventive, each in its own right, include:
the folding seat arrangement where, in general terms, the seat base and backrest are firstly brought together by folding about a first pivot axis, and then they are pivoted about a second pivot axis until they are generally parallel to the plane of the wheels, to facilitate stowage;
the seat height adjustment facility;
the folding footrests that fold away substantially within the external dimensions of the rest of the wheelchair, when folded.

1. A personal vehicle comprising:
a) a collapsible chassis;
b) a plurality of wheels mounted at extremities of the chassis;
c) an upright column supported on the chassis; and
d) a foldable seat supported on the column.

2. A personal vehicle according to claim 1, wherein said collapsible chassis comprises a plurality of structural members that are interconnected such that, in plan view, they are movable between an operational position in which the chassis has a maximum width and a stowage position in which the chassis has a reduced width.

3. A personal vehicle according to claim 2, further comprising locking means arranged to lock said structural members in at least one intermediate position in which the chassis has a width intermediate said maximum and reduced widths.

4. A personal vehicle according to claim 2, wherein said structural members are connected to a common pivot point, for pivoting movement about an upright axis.

5. A personal vehicle according to claim 4, wherein said structural members comprise two members that are pivotally connected in a substantially X-configuration.

6. A personal vehicle according to claim 5, wherein said chassis further comprises at least one guide member to which the structural members are connected such that, as the structural members are moved between said operational and stowage positions, extremities of the chassis maintain a substantially parallel relationship to one another.

7. A personal vehicle according to claim 1, wherein four said wheels are provided at respective extremities of the chassis.

8. (canceled)

9. A personal vehicle according to claim 1 further comprising at least one prime mover arranged to drive at least one of said wheels.

10. A personal vehicle according to claim 9, wherein two driven wheels are provided at the front of the chassis.

11-12. (canceled)

13. A personal vehicle according to claim 9, wherein two said prime movers are provided, each arranged to drive a respective one of said wheels.

14. (canceled)

15. A personal vehicle according to claim 14, further comprising height adjustment means is-arranged to adjust the height of said seat with respect to a surface on which the user's feet rest in use.

16. A personal vehicle according to claim 15, wherein said height adjustment means includes a powered drive arranged to adjust the height of said seat.

17. A personal vehicle according to claim 16, further comprising control means arranged to control said powered drive such that said seat may be adjusted to at least one pre-set height.

18. (canceled)

19. A personal vehicle according to claim 1, wherein said seat comprises a seat squab and a seat back that are arranged to fold together and said seat squab and seat back are arranged to pivot about a substantially horizontal axis when folded together, thereby to bring the seat squab and seat back into or towards alignment with said column.

20. A personal vehicle according to claim 1, wherein said seat is arranged to pivot about an upright axis.

21. A personal vehicle according to claim 1, wherein said seat is provided with armrests that can be moved into and out of operational positions.

22. A personal vehicle according to claim 1, comprising a chassis assembly and a seat assembly that is removable from said chassis assembly.

23. A personal vehicle according to claim 1, provided with at least one removable battery pack that is arranged to power at least one electrical device of the vehicle.

24. A personal vehicle according to claim 1, comprising a wheelchair.

25. A personal vehicle according to claim 1, comprising a scooter.

26. (canceled)
